(19) United States
(12) Patent Application Publication
(10) Pub. No.: US 2006/0294316 A1
(43) Pub. Date: Dec. 28, 2006

(54) Selectively prefetch method and bridge module

(75) Inventor: Kuan-Jui Ho, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/328,105

(22) Filed: Jan. 10, 2006

(30) Foreign Application Priority Data
Jun. 22, 2005 (TW) 094120853

(51) Int. Cl. G06F 12/00

(52) U.S. Cl. 711/137

(57) ABSTRACT

A selectively prefetch method is applied on a bridge module. The bridge module has a prefetch controller and a memory controller, and the prefetch controller at least includes a source comparison register for storing at least one determining reference data. The selectively prefetch method includes the following steps of: receiving an instruction by the bridge module, determining whether the source of the instruction matches a specific source or not by the prefetch controller according to the determining reference data, executing a prefetch action by the prefetch controller through the memory controller when the source of the instruction matches the specific source, and not executing the prefetch action by the prefetch controller when the source of the instruction does not match the specific source.

### BACKGROUND OF THE INVENTION

1. Field of Invention

The invention relates to a selectively prefetch method and a bridge module and, in particular, to a selectively prefetch method and a bridge module used in a computer system.

2. Related Art

Please refer to FIG. 1 showing a schematic view of a conventional personal computer. The conventional personal computer 1 includes a casing (not shown), a mainboard 11, and a monitor 12. The mainboard 11 includes a central processing unit (CPU) 111, a host bus 112, a north bridge module 113, a memory bus 114, a DRAM 115, a south bridge module 116, an I/O (Input/Output) bus 117, an AGP (Advanced Graphical Port) bus 118, and a video graphics array (VGA) card 119. The casing is used to contain the mainboard 11 and at least one peripheral device 13 such as the hard disc drive, optical disc drive, power supply, and the likes. This is the configuration of the well-known computer mainframe. In general, the CPU 111 and the north bridge module 113 are connected with the host bus 112, the north bridge module 113 and the DRAM 115 are connected with the memory bus 114, and the north bridge module 113 and the VGA card 119 are connected with the AGP bus 118.

As mentioned above, the CPU 111 is used to control the overall operations of the personal computer 1. The north bridge module 113 is used to control the signal transmissions between the CPU 111 and the high-speed peripherals such as the DRAM 115. The south bridge module 116 cooperated with the I/O bus 117 is used to control the signal transmissions between the north bridge module 113 and the low-speed peripheral device 13 such as a hard disc drive and an I/O device. The VGA card 119 is used to perform the graphic calculation for generating image signals, which drive the monitor 12.

Accompanying with the progressive technology, the functions of the CPU 111 become more powerful and the executing speed of the CPU 111 becomes faster. As a result, the performance of the personal computer 1 is determined by the speed of the DRAM 115 or the peripheral device 13. For example, when the personal computer 1 executes an application program, the accessing time of the DRAM 115 may occupy the major executing time of the application program. Thus, to reduce the accessing time of the DRAM 115 for enhancing the computer performance is an important subject.

During the period for accessing the DRAM 115, a DRAM controller (not shown) inside the north bridge module 113 firstly receives an address signal from the host bus 112. After decoding the address signal, the corresponding address in the DRAM 115 is found and data can be then read out from or wrote in this address. Since the accessing speed of the DRAM 115 has a limitation, the personal computer 1 usually spends a lot of time on waiting the data accessing from the DRAM 115. Recently, those skilled persons have disclosed a prefetch technology for solving the previously mentioned problem. The prefetch technology is to store the data in a high-speed buffer such as a LRU buffer. If the desired data have been prefetched to a high-speed buffer, the data can be retrieved from the buffer during the read cycle. Accordingly, the accessing time of the DRAM 115 can be efficiently reduced, so that the performance of the personal computer can be enhanced.

However, the conventional prefetch technology is to prefetch data blindly without considering whether the prefetch action of the data is necessary or not. Consequently, when the prefetched data is unnecessary, the overall performance may get worse. Regarding to the modern technology requesting for high performance and utility rate, the unnecessary prefetch action is undesired. Therefore, it is an important subject of the invention to provide a selectively prefetch method and a bridge module that can efficiently prefetch the desired data.

### SUMMARY OF THE INVENTION

In view of the foregoing, the invention is to provide a selectively prefetch method and a bridge module that can efficiently prefetch the desired data.

To achieve the above, a selectively prefetch method of the invention is applied on a bridge module having a prefetch controller and a memory controller. The prefetch controller at least includes a source comparison register for storing at least one determining reference data. The selectively prefetch method includes the following steps of: receiving an instruction by the bridge module; determining whether the source of the instruction matches a specific source or not by the prefetch controller according to the determining reference data; when the source of the instruction does match the specific source, executing a prefetch action by the prefetch controller through the memory controller, and when the source of the instruction not matches the specific source, not executing the prefetch action by the prefetch controller.

In addition, the invention also discloses a bridge module, which is cooperated with a memory, includes a memory controller and a prefetch controller. In the invention, the prefetch controller has a source comparison register for storing at least one determining reference data. The memory controller is used for accessing the memory. The prefetch controller determines whether the source of an instruction matches a specific source or not according to the determining reference data. When the source of the instruction matches the specific source, the prefetch controller executes a prefetch action through the memory controller. In contrary, when the source of the instruction does not match the specific source, the prefetch controller does not execute the prefetch action.

As mentioned above, the selective prefetch method and bridge module of the invention can utilize the prefetch controller to determine whether the source of an instruction matches a specific source or not according to the determining reference data. Then, the prefetch controller executes a prefetch action through the memory controller when the source of the instruction matches the specific source; otherwise, the prefetch controller does not execute the prefetch action when the source of the instruction does not match the specific source. Accordingly, the prefetch action can be selectively executed and would not be performed blindly. Thus, the data can be prefetched efficiently and, furthermore, the entire performance of the computer system can be enhanced.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional personal computer;

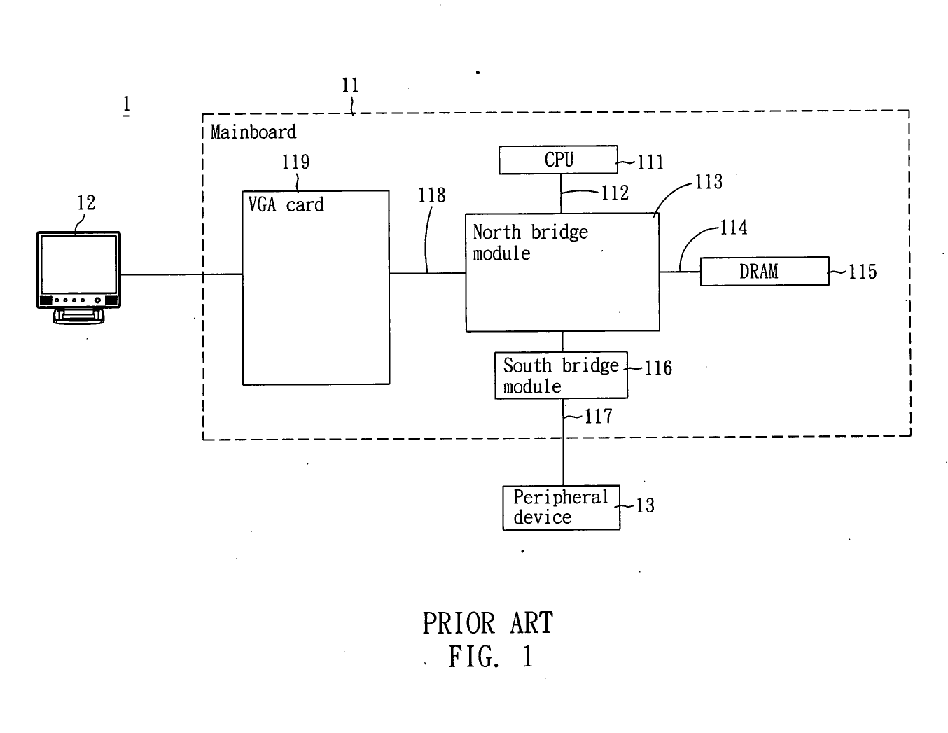

FIG. 2 is a schematic view showing a computer system including a bridge module according to a preferred embodiment of the invention; and

FIG. 3 is a flow chart of a selective prefetch method according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

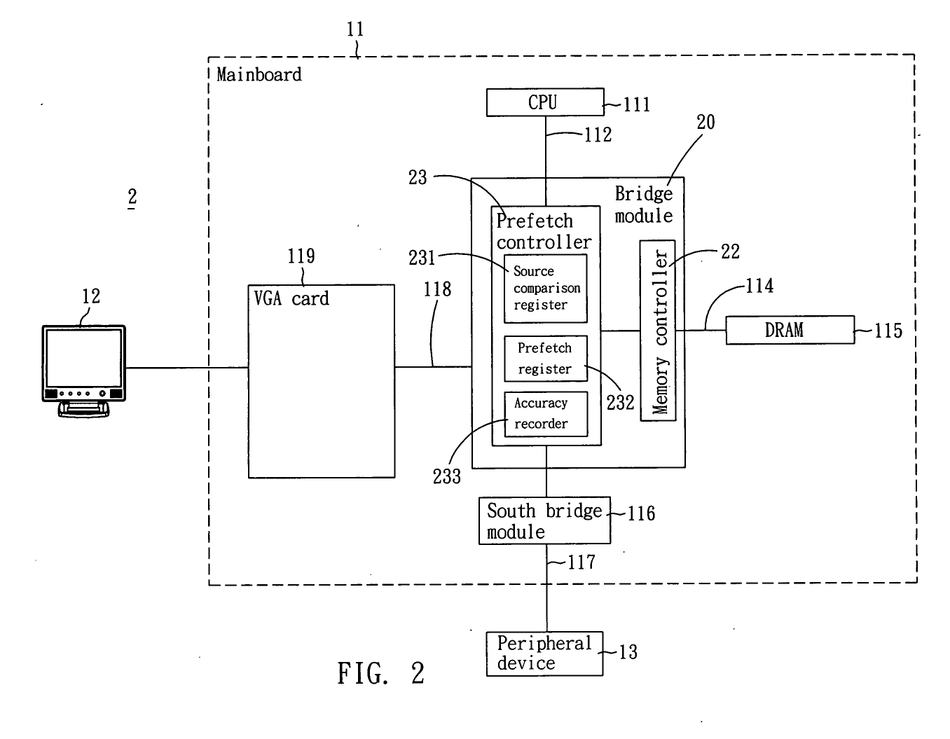

With reference to FIG. 2, a bridge module 20 according to a preferred embodiment of the invention is applied in a computer system 2. The operations of the computer system 2 are similar to those of the previously mentioned personal computer 1. Hereinafter, the detailed descriptions of the operations of the computer system 2 will be omitted for concise purpose. The bridge module 20 is cooperated with a DRAM 115 of the computer system 2. In the following description of this embodiment, prefetching the data in the DRAM 115 is considered.

In the embodiment, the bridge module 20 can be a north bridge module for controlling the signal transmission with the CPU 111. Of course, the bridge module 20 can be an integrated chipset including the north bridge module and south bridge module. The bridge module 20 includes a memory controller 22 and a prefetch controller 23.

The prefetch controller 23 includes a source comparison register 231, a prefetch register 232, and an accuracy recorder 233 for the historical prefetch result.

In the embodiment, the source comparison register 231 stores at least one determining reference data. The determining reference data is, for example, a source reference data. Then, the prefetch controller 23 determines whether the source of an instruction matches a specific source or not according to the determining reference data. Herein, the prefetch register 232 is a high-speed buffer such as an LRU buffer, and it contains the prefetched data and the corresponding address in the prefetch action.

The accuracy recorder 233 analyzes an accuracy of the prefetch action. In more details, the accuracy recorder 233 can calculate and record the ratio of the used prefetched data in all prefetched data. If the current accuracy is higher, the prefetch controller 23 executes the prefetch action; otherwise, if the current accuracy is lower, the prefetch controller 23 does not execute the prefetch action.

The memory controller 22 connects to the DRAM 115, and they are connected to each other through a memory bus 114. The memory bus 114 is used to transmit the data in the DRAM 115, the memory address, and the control signal. Moreover, the memory bus 114 may include a data bus, an address bus, and a control signal bus.

The prefetch controller 23 determines whether the source of an instruction from the CPU 111 or the peripheral device, such as the PCI bus device, matches a specific source or not according to the determining reference data stored in the source comparison register 231. When the source of the instruction matches the specific source, the prefetch controller 23 executes a prefetch action through the memory controller 22. When the source of the instruction does not match the specific source, the prefetch controller 23 does not execute the prefetch action.

In the current embodiment, when the prefetch controller 23 receives a read instruction and the address of the data to be read matches the prefetched address stored in the prefetch register 232, the data is prefetched directly. Thus, the memory controller 22 is unnecessary to run a completely read cycle for obtaining the desired data, so that the data read time can be efficiently reduced.

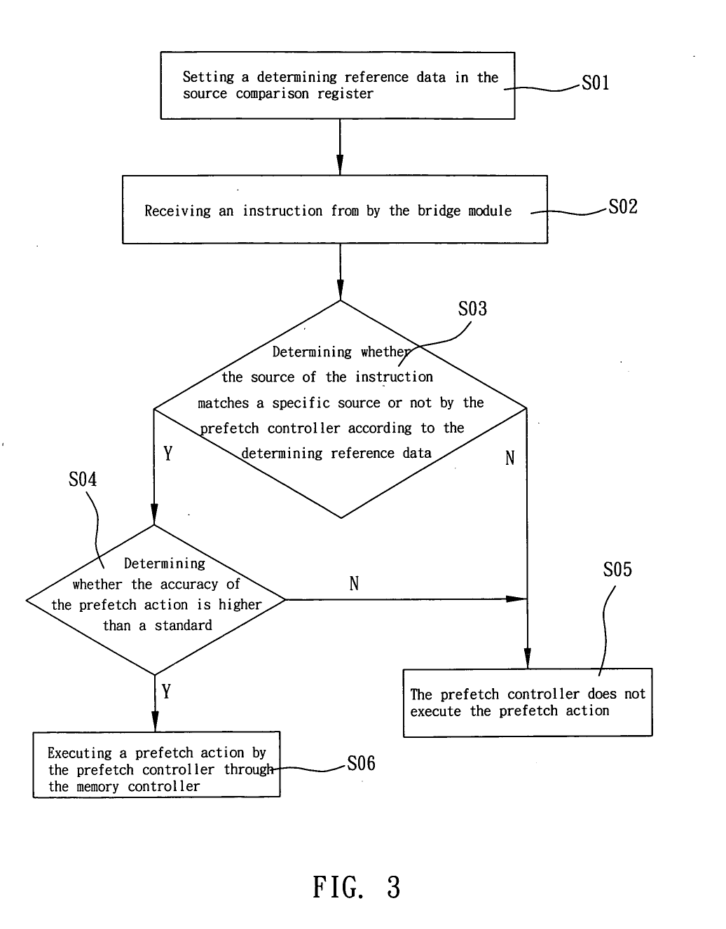

With reference to FIG. 3, which shows a selectively prefetch method according to a preferred embodiment of the invention, the selectively prefetch method of the invention is applied in the above-mentioned bridge module 20. Hereinafter, the operating flows of the bridge module 20 will be described.

In step S01, a determining reference data in the source comparison register 231 is set. In general, the present CPU 111 has the prefetch function. Thus, if the bridge module 20 executes an additional prefetch action for the instruction of the CPU 111, this additional prefetch action may cause the processing time waste. Accordingly, the instruction from the CPU 111 is preferably excluded from the determining reference data. In this case, the when the prefetch controller 23 analyzes that the instruction is issued from the CPU 111, the prefetch action will not be executed so as to eliminate the wasting time for the unnecessary additional prefetch action.

In step S02, the bridge module 20 receives an instruction from, for example, the CPU 111 or the peripheral device 13.

In step S03, the prefetch controller 23 determines whether the source of the instruction matches a specific source or not according to the determining reference data. If the instruction is issued from the CPU 111, the bridge module 20 firstly recognizes that the source of the instruction is issued from the CPU 111. Then, the prefetch controller 23 determines whether the source of the instruction matches a specific source or not according to the determining reference data, and then determines whether to perform the prefetch action or not. Herein, since the CPU 111 is excluded from the determining reference data, the prefetch controller 23 determines that the source of the instruction does not match the specific source, and step S05 is then performed. Alternatively, if the instruction is issued from the peripheral device 13, such as a PCI bus device, the prefetch controller 23 determines that the source of the instruction matches the specific source, and step S04 is then performed.

In step S04, the prefetch controller 23 analyzes an accuracy of the historical prefetch result stored in the accuracy recorder 233 to determine whether the accuracy of the prefetch action is higher than a standard. If the current accuracy is higher than the standard, step S06 is then performed. Otherwise, if the current accuracy is lower than the standard, step S05 is then performed.

In step S05, the prefetch controller 23 does not execute the prefetch action. In this step, the prefetch controller 23 determines the source of the instruction does not match a specific source according to the determining reference data, so that the prefetch controller 23 would not execute the prefetch action. In addition, when the prefetch controller 23 analyzes the accuracy of the historical prefetch result stored in the accuracy recorder 233 to determine the accuracy of the prefetch action is lower than the standard, the prefetch controller 23 would not execute the prefetch action, too.

In step S06, the prefetch controller 23 executes a prefetch action through the memory controller 22.

In summary, the selective prefetch method and bridge module of the invention can utilize the prefetch controller to determine whether the source of an instruction matches a specific source or not according to the determining reference data. Then, the prefetch controller executes a prefetch action through the memory controller when the source of the instruction matches the specific source; otherwise, the prefetch controller does not execute the prefetch action when the source of the instruction does not match the specific source. Accordingly, the prefetch action can be selectively executed and would not be performed blindly. Thus, the data can be prefetched efficiently and, furthermore, the entire performance of the computer system can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A selectively prefetch method, which is applied on a bridge module having a prefetch controller and a memory controller, wherein the prefetch controller at least comprises a source comparison register for storing at least one determining reference data, comprising:
receiving an instruction by the bridge module;
determining whether the source of the instruction matches a specific source or not by the prefetch controller according to the determining reference data; and
executing a executing a prefetch action by the prefetch controller through the memory controller when the source of the instruction matches the specific source.

2. The method of claim 1, wherein the prefetch action is not executed by the prefetch controller when the source of the instruction does not match the specific source.

3. The method of claim 1, wherein the prefetch controller further comprises a prefetch register, and the method further comprises:
storing a prefetch data obtained by the prefetch action and an address of the prefetch data in the prefetch register.

4. The method of claim 1, wherein the determining reference data is a source reference data.

5. The method of claim 4, wherein the prefetch controller further comprises an accuracy recorder for a historical prefetch result, and the method further comprising:
analyzing and recording an accuracy of the prefetch action by the accuracy recorder; and
setting the source of the instruction as the source reference data when the accuracy of the prefetch action is higher than a standard.

6. The method of claim 1, wherein the instruction is issued by a central processing unit (CPU).

7. The method of claim 1, wherein the instruction is issued by a computer peripheral device.

8. The method of claim 1, wherein the bridge module is a north bridge chip.

9. The method of claim 1, wherein the bridge module is an integral chip.

10. A bridge module cooperated with a memory, comprising:
a memory controller for accessing the memory; and
a prefetch controller having a source comparison register for storing at least one determining reference data, wherein the prefetch controller determines whether the source of an instruction matches a specific source or not according to the determining reference data.

11. The bridge module of claim 10, wherein the prefetch controller executes a prefetch action through the memory controller when the source of the instruction matches the specific source.

12. The bridge module of claim 10, wherein the prefetch controller does not execute the prefetch action when the source of the instruction does not match the specific source.

13. The bridge module of claim 10, wherein the prefetch controller further comprises a prefetch register, and a prefetch data obtained by the prefetch action and an address of the prefetch data are stored in the prefetch register.

14. The bridge module of claim 10, wherein the instruction is issued by a central processing unit (CPU).

15. The bridge module of claim 10, wherein the instruction is issued by a computer peripheral device.

16. The bridge module of claim 10, wherein the bridge module is a north bridge chip.

17. The bridge module of claim 10, wherein the bridge module is an integral chip.

18. The bridge module of claim 10, wherein the determining reference data is a source reference data.

19. The bridge module of claim 18, wherein the prefetch controller further comprises an accuracy recorder for a historical prefetch result, and the accuracy recorder analyzes and records an accuracy of the prefetch action and sets the source of the instruction as the source reference data when the accuracy of the prefetch action is higher than a standard.
